(19) United States
(12) Patent Application Publication
(10) Pub. No.: US 2008/0007711 A1
(43) Pub. Date: Jan. 10, 2008

(54) Range finder

(75) Inventor: Yi Liu, Nanjing (CN)

Correspondence Address: MCDERMOTT WILL & EMERY LLP, 227 WEST MONROE STREET, CHICAGO, IL, 60606-5096, US

(73) Assignee: Nanjing Chervon Industry Co., Ltd.

(21) Appl. No.: 11/387,371

(22) Filed: Mar. 23, 2006

(30) Foreign Application Priority Data
Mar. 24, 2005 (CN) 200520070097.X

(51) Int. Cl. G01C 3/08; G02B 23/24

(52) U.S. Cl. 356/5.11; 356/4.01; 356/5.01; 359/362

(57) ABSTRACT

The present invention is generally directed to a range finder for measuring short and long distances via a simple, compact and stable structure without increasing the cost and the size of the device. The range finder according to the present invention comprises a light source for generating a measuring beam, a circuit for modulating the light source, a collimating objective lens, a receiving objective lens, an auxiliary lens or a group of auxiliary lenses, an optoelectronic receiver, a control and calculating unit, and a display unit.

### CROSS-REFERENCE TO RELATED APPLICATIONS

This application claims priority to Chinese Application No. 200520070097.X, filed on Mar. 24, 2005.

### FEDERALLY SPONSORED RESEARCH OR DEVELOPMENT

Not applicable.

### TECHNICAL FIELD

The present invention relates to a range finder, and more particularly to an optical range finder which emits a measuring beam and measures a distance by receiving the measuring beam reflected from an object to be measured and comparing the emitted measuring beam and the reflected measuring beam to obtain a difference between them.

### BACKGROUND OF THE INVENTION

Range finders are well-known in many fields, such as geodesic surveying, construction surveying, three-dimensional surveying during indoor decoration, and so on. Range finders, especially optical distance measurement devices, are in favor with many consumers in the present market due to high measurement accuracy, short operating time, and large measuring range. A foundational principle of distance measurement utilized in the known devices is based on the phase measurement principle or the flight time principle. The furthest distance which can be measured by this type of optical range finder may be up to several tens of meters when the object which is to be measured has natural rough surfaces, and may also be up to several hundred meters if a reflecting surface is attached to the object to be measured.

As shown in FIG. 1, a typical optical range finder in the prior art comprises a light source 11, a collimating objective lens 12, a receiving objective lens 14, an optoelectronic receiver 15, a modulating circuit 17 for modulating the light source so that the latter can emit a modulated measuring beam, a control and calculating unit 18, and a display unit 19 for displaying a result of a distance measurement. An optical axis of the collimating objective lens 12 is parallel to an optical axis of the receiving objective lens 14. The optoelectronic receiver 15 is provided with a light receiving surface 16 which is located at a focal point A of the receiving objective lens 14. In addition, in order to compensate for error resulting from drift effects in the electronics and in the optoelectronic receiver, and to compare phases before and after the external distance measurement, it is well-known that the range finder further comprises a reference optical path which provides a reference distance of a predetermined length to be measured by the range finder in order to improve the accuracy of the device.

The measuring beam reflected from a far-removed object (not shown) appears to be a parallel beam, so that the image location of the reflected measuring beam passing through the receiving objective lens 14 lies at the focal point A, i.e., on the light receiving surface 16 of the optoelectronic receiver 15 (as shown in solid lines in FIG. 1). The measuring beam reflected from a closer object 13 to be measured is obviously inclined with respect to the optical axis of the receiving objective lens 14, so that the image location lies behind the focal point A and deviates from the optical axis of the receiving objective lens 14 (as shown in dashed lines in FIG. 1), with the result being that the distance measurement is unable to be taken due to the light receiving surface 16 failing to receive the reflected measuring beam.

Many attempts have been made to try to solve the problems occurring in short distance measurements. For example, with the aid of a reflecting mirror 21, as shown in FIG. 2, and a prism 22, as shown in FIG. 3, the short distance measurement problem can be improved to a great extent. However, the reflected measuring beam can not be deflected onto the light receiving surface 16 by using the reflecting mirror 21 or the prism 22 alone when the distance to be measured is very short, for example, several centimeters, and the reflected measuring beam inclines greatly. This is due to the limited deflection capabilities of the reflecting mirror 21 and the prism 22. This is obviously inconvenient for users who need to measure distances of several centimeters only. Certainly, the reflected measuring beam can be deflected onto the light receiving surface 16 by placing a series of reflecting mirrors 21 or prisms 22 in some appropriate positions or moving the reflecting angle of the reflecting mirror 21 based on detecting and analyzing the inclination of the reflected measuring beam. But, such solutions increase the complexity of the device and cause manufacturing difficulties, thereby increasing the cost of the range finder, as well.

Multi-optoelectronic receivers utilized in some range finders to expand the area of the light receiving surface also achieve a good effect for measuring short distances. But, it should be noted that the cost of the optical range finder will increase greatly as the number of optoelectronic receivers is increased. In fact, the optoelectronic receiver is the most expensive element in the range finder.

There are some other range finders that can measure a sufficient short distance, e.g., a distance between the object to be measured and the front end of the housing, via increasing the length of the housing of the device so as to increase the distance between the receiving objective lens and the front end of the housing. But, accordingly, the size of the housing of the range finder is thus increased, which is not good for the miniaturization of the range finder.

### SUMMARY OF THE INVENTION

It is an object of the present invention to provide a range finder, the minimum measurable distance of which can be further shortened, while the device is also adaptable to take long distance measurements, the device being of a simple and stable construction without the increased cost or the increased size found in the prior art discussed above.

To achieve the above-mentioned object, the present invention provides a range finder comprising a light source for emitting a measuring beam, a circuit for modulating the light source to make it emit a modulated measuring beam, a collimating objective lens for collimating the measuring beam emitted from the light source, a receiving objective lens for receiving and imaging a reflected measuring beam reflected back from an object to be measured, an optoelectronic receiver for receiving an image of the reflected measuring beam and converting the optical signals therein into corresponding electrical signals, a cylindrical-surfaced lens or a group of cylindrical-surfaced lenses for diffusing the beam, a control and calculating unit, and a display unit for displaying resulting distance measurements.

### BRIEF DESCRIPTION OF THE DRAWINGS

The preferred embodiments of the present invention will be illuminated in more detail below with reference to the following drawings:

FIG. 1 is a schematic diagram of an internal structure of a typical optical range finder of the prior art;

FIG. 2 is a schematic diagram of a receiving optical path of the prior art, which comprises a reflecting mirror to deflect a reflected measuring beam;

FIG. 3 is a schematic diagram of a receiving optical path of the prior art, which comprises a prism to deflect the reflected measuring beam;

FIG. 4 is a perspective view of one embodiment of a cylindrical-surfaced lens according to the present invention;

FIG. 5 is a front view of the lens of FIG. 4;

FIG. 6 is a top view of the lens of FIG. 4;

FIG. 7 is another embodiment of a cylindrical-surfaced lens according to the present invention;

FIG. 8 is another embodiment of a cylindrical-surfaced lens according to the present invention; and,

FIG. 9 is a schematic diagram of an internal structure of a range finder according to the present invention.

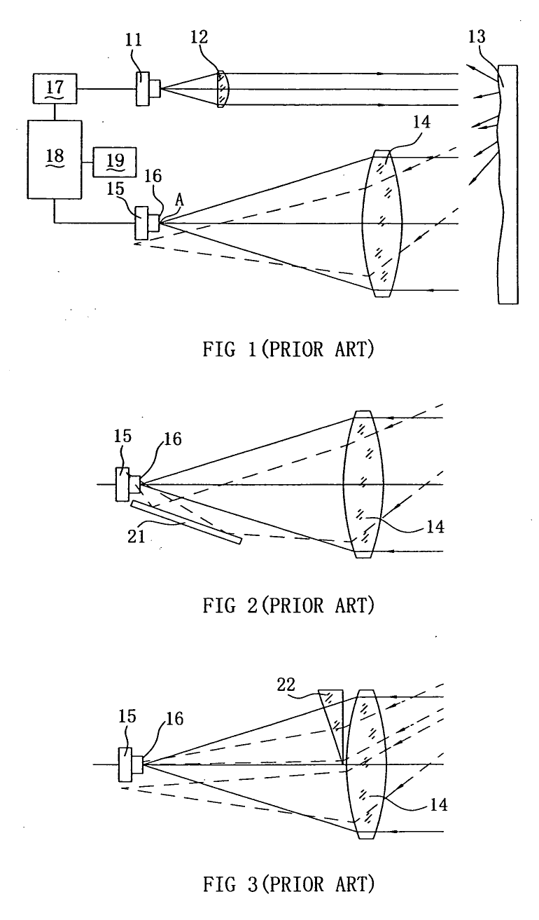

### DETAILED DESCRIPTION

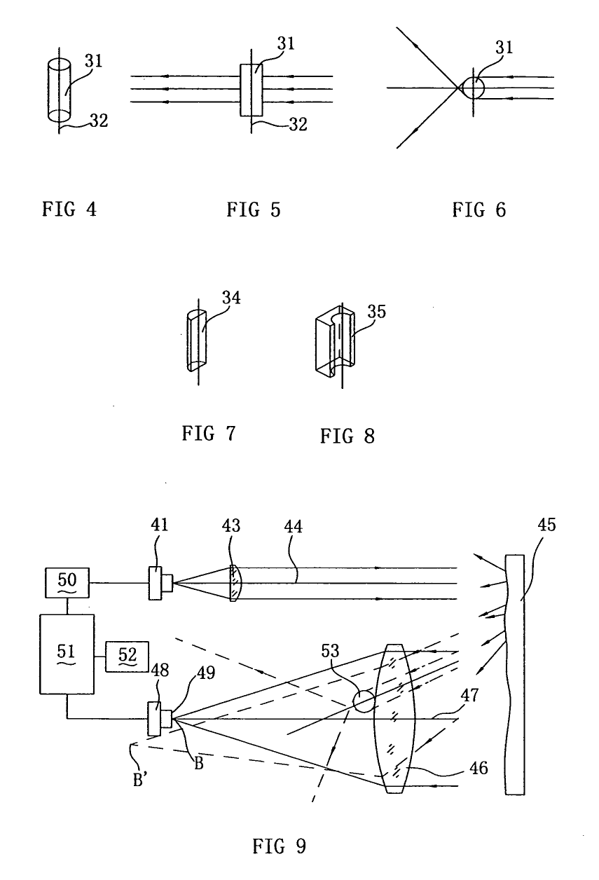

An auxiliary lens or group of auxiliary lenses can be used to enable a range finder to take short distance measurements accurately. Such auxiliary lenses include a cylindrical-surfaced lens 31 and other cylindrical-surfaced optical elements. FIGS. 4 through 6 show a typical cylindrical-surfaced lens 31 with a cylindrical shape. After passing through the cylindrical-surfaced lens 31, the beam still transmits along its original direction on a longitudinal axis 32 of the lens (see FIG. 5), and, meanwhile, the beam is focused first and then diverged in first and second directions perpendicular to each other (see FIG. 6). According to practical requirements, the diverging angle of the beam can be designed to be any angle between 30 degrees and 120 degrees by using cylindrical-surfaced lenses with different refractive indices. Alternatively, the cylindrical-surfaced optical element can take the form of a part-cylindrical lens 34, as shown in FIG. 7, a concave cylindrical-surfaced lens 35, as shown in FIG. 8, and other similar structures. Additionally, besides a single cylindrical-surfaced lens 31, it is also contemplated that a compound lens consisting of a lot of cylindrical surfaces of different focal lengths can be used. It is also contemplated that a group of single cylindrical-surfaced lenses 31 can be arranged. It is understood by those of ordinary skill in the art that all of these variations of cylindrical-surfaced lenses 31 can be used to convert the beam into a diverging beam with a certain diverging angle.

FIG. 9 shows a preferred embodiment of the internal structure of the range finder according to the present invention. The range finder of the preferred embodiment comprises a light source 41 for emitting a measuring beam to an object 45 to be measured, a circuit 50 for modulating the frequency of the light source 41 to cause emission of a modulated measuring beam, a collimating objective lens 43 for collimating the measuring beam emitted from the light source 41 along the direction of a first optical axis 44, a receiving objective lens 46 for receiving and imaging a reflected measuring beam back from the object 45 to be measured, an optoelectronic receiver 48 for receiving the image of the measuring beams and converting the optical signals therein into corresponding electrical signals, a cylindrical-surfaced lens 53 installed close to the receiving objective lens 46, a control and calculation unit 51 coupled to the optoelectronic receiver 48 and the modulating circuit 50, and a display unit 52 coupled to the control and calculation unit 51 for displaying results of distance measurements. The light receiving surface 49 of the optoelectronic receiver 48 lies at the focal point B of the receiving objective lens 46. The light source 41 can be any type of visible or invisible light source suitable for taking optical distance measurements. If an invisible light source is used, another visible light source can be attached to the device for projecting a light mark on the measured object 45. The range finder of the present invention can also comprise a reference optical path to improve the accuracy of the distance measurement.

The optoelectronic receiver 48 receives the reflected measuring beam back from the measured object 45 and outputs corresponding electrical signals containing phase information of the reflected measuring beam when the range finder measures the distance to the object 45 based on the phase measurement principle. The control and calculation unit 51 receives and processes the electrical signals from the optoelectronic receiver 48 to obtain a phase difference of the measuring beam before the measuring beam is emitted and after the reflected measuring beam is received so as to calculate the distance between the range finder and the object 45 to be measured. Then, the measured distance is displayed by the display unit 52. The control and calculation unit 51 further controls the modulating circuit 50 to modulate the light source 41. If the range finder measures the distance based on the flight time principle, the control and calculation unit 51 can also measure a flight time of the measuring beam on the path of measurement to obtain the distance to the object 45 to be measured.

For longer distance measurements, the reflected measuring beam passes through the receiving objective lens 46 and is imaged at focal point B, i.e., on the light receiving surface 49 of the optoelectronic receiver 48. For shorter distance measurements, the reflected measuring beam is inclined with respect to a second optical axis 47, and, thus, the reflected measuring beam, which is received by the receiving objective lens 46, is imaged at point B′ deviating from the light receiving surface 49. The cylindrical-surfaced lens 53 has the same light deflection ability in all directions in a plane perpendicular to its longitudinal axis 32, so that the reflected measuring beam which passes through the cylindrical-surfaced lens 53 can always be a fan-shaped light of a certain big angle, which covers the light receiving surface 49 of the optoelectronic receiver 48 sufficiently, regardless of the diverging degree of the reflected measuring beam. The intensity of the reflected measuring beam for shorter distance measurements is extremely strong, so that the optoelectronic receiver 48 can be actuated to output enough electrical signals for calculation even when the light receiving surface 49 receives only a small portion of the reflected measuring beam passing through the cylindrical-surfaced lens 53.

The cylindrical-surfaced lens 53 or other suitable auxiliary lens converts the reflected measuring beam into a fan-shaped beam having a certain diverging angle, thereby resulting in the light receiving surface 49 of the optoelectronic receiver 48 receiving enough light from the reflected measuring beam to continue the distance measurement even if the distance from the receiving objective lens 46 to the measured object 45 is extremely short, for example, several centimeters.

In the present preferred embodiment, the cylindrical-surfaced lens 53 and the receiving objective lens 46 are two optical elements separated from each other. It is understood by those skilled in the art that the same function can be achieved using a special compound lens, which consists of a receiving objective lens, a part of which is cylindrical-surfaced.

In the present preferred embodiment, the light receiving surface 49 of the optoelectronic receiver 48 is the light-sensitive surface of the optoelectronic receiver 48, itself. It is understood by those skilled in the art that an optical fiber can be coupled to the light receiving surface 49 of the optoelectronic receiver 48, with one end of the optical fiber positioned far away from the light-sensitive surface 49 being used as the light receiving surface 49 of the optoelectronic receiver 48. Similarly, as is readily apparent to those of ordinary skill in the art, other elements, which can be used as the light receiving surface 49, are suitable, too.

A user can measure even a short distance of 1 centimeter from the receiving objective lens 46 to the measured object 45 with the range finder of the present invention. Therefore, so long as the distance between the front end of the range finder and the receiving objective lens 46 is greater than or equal to 1 centimeter, the measurement of any distance between 0 and the greatest measuring range can be realized. The cylindrical-surfaced lens 53 is so inexpensive that its addition will not meaningfully affect the total cost of the device. The internal structure of the range finder according to the present invention is simple and compact, with the result being that the device is adaptable to miniaturization and specifically lends itself to being provided as a kind of hand-held range finder.

The above described preferred embodiments are intended to illuminate the principles of the present invention, but not to limit its scope. It is understood by those skilled in the art that many other modifications and variations of these preferred embodiments will be apparent and may be made without departing from the spirit and the scope of the invention as defined in the following claims.

1. A range finder for measuring a distance to an object to be measured, the range finder comprising:
a light source for emitting a visible measuring beam in the direction of the object to be measured;
a collimating objective lens for collimating the measuring beam emitted from the light source;
a receiving objective lens for receiving and imaging a reflected measuring beam reflected back from the object to be measured;
an optoelectronic receiver for receiving the image of the reflected measuring beam and converting optical signals therein into corresponding electrical signals, the optoelectronic receiver comprising a light receiving surface, the light receiving surface being located at a focal point of the receiving objective lens;
a modulation circuit for frequency-modulating the light source causing it to emit a modulated measuring beam;
a control and calculation unit electrically coupled to the optoelectronic receiver and the modulation circuit;
a display unit coupled to the control and calculation unit for displaying results of distance measurements; and,
an auxiliary lens or group of auxiliary lenses for converting the reflected measuring beam, which is inclined with respect to an optical axis of the receiving objective lens in short distance measurements, into a diverging beam of a certain diverging angle, the diverging beam contacting the light receiving surface of the optoelectronic receiver.

2. The range finder of claim 1 wherein the reflected measuring beam diverges to simultaneously cover a range of the certain diverging angle after it passes through the auxiliary lens or group of auxiliary lenses.

3. The range finder of claim 1 wherein the auxiliary lens and the receiving objective lens are separate from each other.

4. The range finder of claim 1 wherein the auxiliary lens is formed on the receiving objective lens as a compound lens.

5. The range finder of claim 1 wherein the auxiliary lens is a cylindrical-surfaced optical element.

6. The range finder of claim 5 wherein the cylindrical-surfaced optical element is a cylindrical-surfaced lens with a single focal length.

7. The range finder of claim 5 wherein the cylindrical-surfaced optical element is a compound lens comprising multiple cylindrical surfaces with different focal lengths.

8. The range finder of claim 5 wherein the cylindrical-surfaced optical element comprises a group of cylindrical-surfaced lenses.

9. A range finder for measuring a distance to an object to be measured, the range finder comprising:
a light source;
a collimating objective lens;
a receiving objective lens;
an optoelectronic receiver having a light receiving surface;
a modulation circuit;
a control and calculation unit electrically coupled to the optoelectronic receiver and the modulation circuit;
a display unit; and,
an auxiliary lens for converting the reflected measuring beam, which is inclined with respect to an optical axis of the receiving objective lens in short distance measurements, into a diverging beam of a certain diverging angle, the diverging beam contacting the light receiving surface of the optoelectronic receiver.

10. The range finder of claim 9 wherein the reflected measuring beam diverges to simultaneously cover a range of the certain diverging angle after it passes through the auxiliary lens.

11. The range finder of claim 9 wherein the auxiliary lens is formed on the receiving objective lens as a compound lens.

12. The range finder of claim 9 wherein the auxiliary lens is a cylindrical-surfaced optical element.

13. The range finder of claim 12 wherein the cylindrical-surfaced optical element is a cylindrical-surfaced lens with a single focal length.

14. the range finder of claim 12 wherein the cylindrical-surfaced optical element is a compound lens comprising multiple cylindrical surfaces with different focal lengths.

15. The range finder of claim 12 wherein the cylindrical-surfaced optical element comprises a group of cylindrical-surfaced lenses.

16. A range finder for measuring a distance to an object to be measured, the range finder comprising:
a light source;
a collimating objective lens;
a receiving objective lens;
an optoelectronic receiver having a light receiving surface;
a modulation circuit;
a control and calculation unit electrically coupled to the optoelectronic receiver and the modulation circuit;
a display unit; and,
a cylindrical-surfaced optical element.

17. The range finder of claim 16 wherein the cylindrical-surfaced optical element is formed on the receiving objective lens as a compound lens.

18. The range finder of claim 16 wherein the cylindrical-surfaced optical element is a cylindrical-surfaced lens with a single focal length.

19. The range finder of claim 16 wherein the cylindrical surfaced optical element is a compound lens comprising multiple cylindrical surfaces with different focal lengths.

20. The range finder of claim 16 wherein the cylindrical-surfaced optical element comprises a group of cylindrical-surfaced lenses.
